(19) United States
(12) Patent Application Publication
(10) Pub. No.: US 2018/0276588 A1
(43) Pub. Date: Sep. 27, 2018

(54) CONNECTION ESTABLISHMENT ASSISTANCE SYSTEM

(71) Applicant: INFOMART CORPORATION, Tokyo (JP)

(72) Inventors: Katsuteru MURAKAMI, Tokyo (JP); Osamu NAGAHAMA, Tokyo (JP); Youichi ISOBE, Tokyo (JP); Tsutomu KODAMA, Tokyo (JP); Ryutaro HAKOZAKI, Tokyo (JP); Kazuma MASUDA, Tokyo (JP)

(21) Appl. No.: 15/748,864

(22) PCT Filed: Aug. 2, 2016
(86) PCT No.: PCT/JP2016/072611

§ 371 Date: Jan. 30, 2018

(30) Foreign Application Priority Data
Aug. 3, 2015 (JP) 2015-153558

(51) Int. Cl. G06Q 10/06

(52) U.S. Cl. CPC G06Q 10/06314; G06Q 10/06315; G06Q 10/06311

(57) ABSTRACT

A connection establishment support system includes: a company classification unit 15 that classifies companies, as seen from a specific user, into a first type of company connected as an individual person, a second type of company connected as a company, and a third type of company having no connection either as an individual person or as a company; a type-based connection request unit 17 that performs a connection request using different methods depending on the type of company classified; and a connection update unit 14 that, when a manipulation for permission is performed by an individual person receiving the connection request, additionally stores connection information representing a relationship of new connection between the specific user and the individual person who performs the permission in a connection information storage unit 22. It is possible to perform a new connection request using different methods by classifying companies into three types depending on a connection method between companies and between individual persons, and establish a new connection in response to permission performed by the individual person receiving the request.

### TECHNICAL FIELD

The present invention relates to a connection establishment support system, and particularly to, a technology suitable for used in a system for supporting connection establishment between individual persons and between companies.

### BACKGROUND ART

In order for companies to continue and expand their businesses, it is important not only to explore more transactions with existing clients but also to strategically implement new development to find new business partners. In addition, it is also important to obtain transactions with better vendors as a partner responsible for purchasing, manufacturing, sales, or the like. For this purpose, various services for supporting expansion of business transactions between companies have been provided in the art. For example, representative services include inquiries of companies using databases, introduction or mediation of vendors to membership companies, hosting of a fellowship meeting or a business meeting, and the like.

Note that a company transaction is finally a transaction between people and people. Therefore, it is indispensable to expand a clique in order to expand transactions. However, the service of the related art described above is mainly for matching companies, and does not support expansion of the clique. Although the fellowship meeting contributes to expansion of the clique at a certain level, the expansion of the clique is limited to persons who actually met at the fellowship meeting. Furthermore, some participants do not necessarily desire to be a new client, and participation in the fellowship meeting does not result in a good result in some cases.

Note that a system that promotes establishment of a new human relationship on a social networking service (SNS) is known in the art (for example, see Patent Literatures 1 and 2). The introduction support device described in Patent Literature 1 has a membership DB that stores identification information of a user and identification information of a user who has a friendship with this user. When a user who desires to be introduced designates an interested community and an introduction range of the introduction target user (for example, up to a friend of a friend), identification information of the user to be introduced is extracted on the basis of the identification information of the user received from the membership DB and the introduction range. As a result, it is possible to introduce users with higher reliability by taking advantage of a human network.

In the information providing device discussed in Patent Literature 2, when a first user designates a second desired user on a dedicated screen, an introduction screen including a list of communities to which the first and second users affiliate in common is provided to a terminal of the first user. The first user can know topics or concerns common to the second unknown user, who has accessed the introduction screen of the first user but has no friendship yet, by referring to the list of communities.
Patent Literature 1: JP 2008-186284 A
Patent Literature 2: JP 2007-328723 A

### DISCLOSURE OF INVENTION

However, both the techniques of Patent Literatures 1 and 2 merely support expansion of social networking partners on the SNS, and do not support establishment of a clique necessary in expansion of company transactions.

In view of such problems, an object of the invention is to effectively support establishment of a clique necessary in expansion of company transactions.

In order to address the aforementioned problems, according to the present invention, companies are classified, as seen from a specific user, into a first type of company including an individual person having a connection with the specific user, a second type of company including an individual person having a connection with someone else of the company to which the specific user belongs, and a third type of company not including an individual person having a connection with the specific user or an individual person of the company to which the specific user belongs, and a connection request from the specific user to a new individual person is performed using different methods depending on the classified type of company. That is, an individual person satisfying the extraction condition is extracted out of individual persons stored in the company data storage unit on the basis of an extraction condition depending on the type of the company, and the extracted individual person is notified of a fact that there is a connection request from the specific user. In addition, when a manipulation for permission is performed by the individual person receiving the connection request, connection information representing a relationship of new connection between the specific user and the individual person who performs the permission is additionally stored in a connection information storage unit.

According to the present invention described above, it is possible to perform a new connection request using different methods corresponding to three types of companies depending on how individual persons between companies are connected, and establish a new connection in response to permission performed by the individual person receiving the request. That is, a user can establish a new connection with another individual person through an individual person already having a connection with the user, and can establish a new connection with another individual person using a connection possessed by someone of the company to which the user belongs. In addition, a user can perform a connection request to an individual person of the company having no connection with any one belonging to the same company as that of the user and establish a new connection. As a result, by appropriately utilizing the three types of connection requests, it is possible to effectively support establishment of a clique necessary to expand company transactions.

### BRIEF DESCRIPTION OF DRAWINGS

FIG. 1 is a diagram illustrating an exemplary whole configuration of a connection establishment support system according to an embodiment of the invention.

FIG. 2 is a block diagram illustrating an exemplary functional configuration of a server device according to an embodiment of the invention.

FIG. 3 is a diagram for describing three types of companies classified by a company classification unit according to an embodiment of the invention.

FIG. 4 is a diagram illustrating exemplary values on an operation screen provided when a specific user requests a connection to an individual person belonging to a first type of company.

FIG. 5 is a diagram illustrating an exemplary operation screen provided when a specific user requests a connection to an individual person belonging to a second type of company.

FIG. 6 is a diagram illustrating an exemplary operation screen provided when a specific user requests a connection to an individual person belonging to a third type of company.

FIG. 7 is a diagram illustrating another exemplary operation screen provided when a specific user requests a connection to an individual person belonging to a third type of company.

FIG. 8 is a diagram illustrating an exemplary sequence when a specific user has another individual person introduced by the individual person belonging to a first type of company.

FIG. 9 is a diagram illustrating an exemplary sequence when a specific user has an individual person of the second type of company introduced by an individual person belonging to the same company as that of the specific user.

FIG. 10 is a diagram illustrating an exemplary sequence when a specific user requests a connection to the company classified into the second type.

### BEST MODE FOR CARRYING OUT THE INVENTION

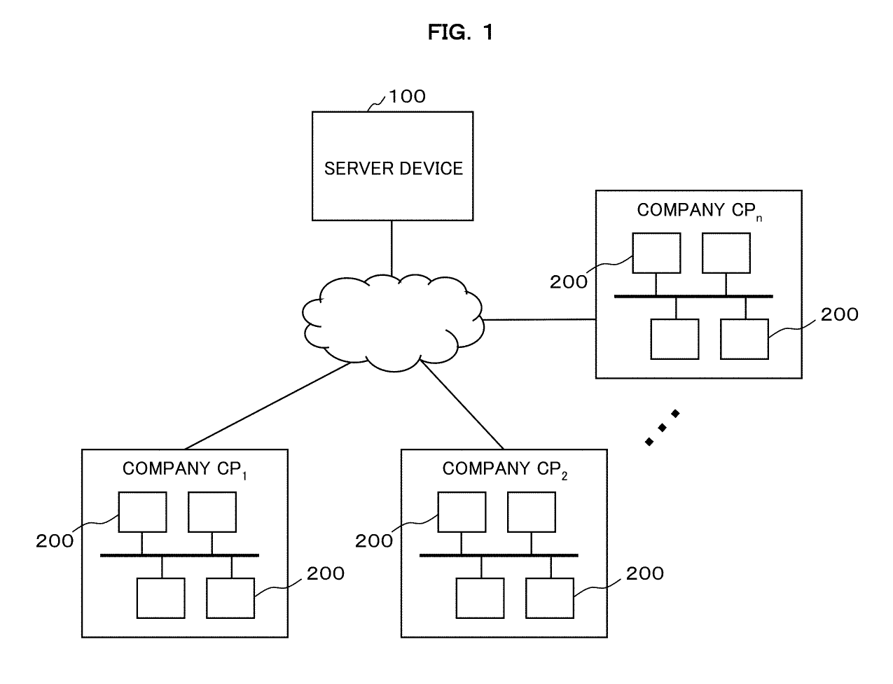

An embodiment of the invention will now be described with reference to the accompanying drawings. FIG. 1 is a diagram illustrating an exemplary whole configuration of a connection establishment support system according to this embodiment. As illustrated in FIG. 1, the connection establishment support system according to this embodiment includes a server device 100 and a plurality of user terminals 200. The server device 100 and a plurality of user terminals 200 are connected to each other via a communication network such as the Internet.

A plurality of user terminals 200 are terminals used by a plurality of individual persons (users such as employees) respectively belonging to a plurality of companies CP₁ to CPₙ (where “n” denotes any integer). A plurality of user terminals 200 used by users belonging to the same company are connected to each other via a local area network (LAN). Alternatively, when a single company has a plurality of base points, the LAN may be constructed in each base point, and the base points may be connected to each other via a wide area network (WAN).

In the connection establishment support system according to this embodiment, users can access the server device 100 from a plurality of user terminals 200 and can use the functions of the server device 100 using the user terminals 200. The function provided by the server device 100 includes a function of supporting establishment of a connection (clique) between users who use a plurality of user terminals 200.

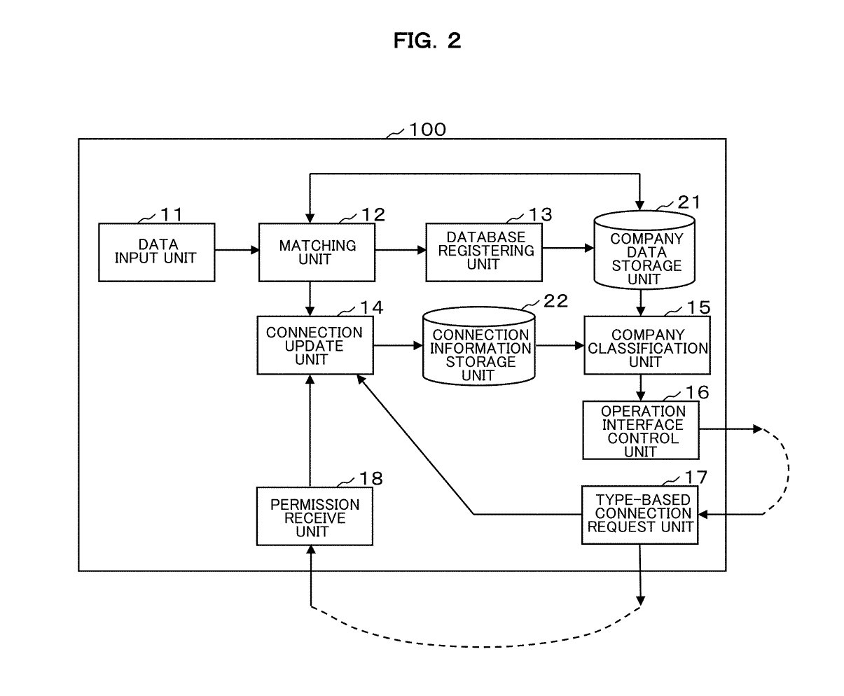

FIG. 2 is a block diagram illustrating an exemplary functional configuration of the server device 100 according to this embodiment. As illustrated in FIG. 2, the functional configuration of the server device 100 according to this embodiment includes a data input unit 11, a matching unit 12, a database registering unit 13, a connection update unit 14, a company classification unit 15, an operation interface control unit 16, a type-based connection request unit 17, and an permission receive unit 18. In addition, the server device 100 according to this embodiment includes a company data storage unit 21 and a connection information storage unit 22 as a database.

Each of the functional blocks 11 to 18 described above may be configured as hardware, a digital signal processor (DSP), or software. For example, in the case of software, each of the functional blocks 11 to 18 described above includes a central processing unit (CPU), a random access memory (RAM), a read-only memory (ROM), or the like of a computer in practice and is implemented by operating a program stored in a recording medium such as the RAM, the ROM, a hard disk, and a semiconductor memory.

The data input unit 11 inputs data (hereinafter, referred to as “company data”) including information on a company and information on individual persons belonging to the company. The information on the company includes, for example, a name of company, a name of base point, a postal code, an address, a phone number, a facsimile number, a uniform resource locator (URL), a representative's name, and the like. The information on an individual person includes, for example, a name, a mail address, a division, and the like. An example of the company data containing such information is business card data.

The company data may be client data registered in a database such as a marketing support system (or sales force automation: SFA) or an accepting/ordering system. In this case, the company of the client may include a company registered as a prospective client as well as a company under transaction in practice. In addition, the company data may also be client list data of a company that provides a membership service.

The data input unit 11 may input a plurality of company data by uploading them at once. Alternatively, individual company data may be input at any timing one by one as necessary. For example, the data input unit 11 may collectively input a plurality of company data exported from databases such as a business card management system, a marketing support system, and an accepting/ordering system. Alternatively, the data input unit 11 may also input the individual company data transmitted from the user terminal 200 one by one at any timing.

The matching unit 12 compares the company data input through the data input unit 11 and the company data already registered in the company data storage unit 21 with each other and performs a matching process regarding company identity and individual person identity. That is, the matching unit 12 determines whether or not the company specified by the company data input through the data input unit 11 is identical to the company specified by the company data already registered in the company data storage unit 21 on the basis of the company information. If it is determined that the companies are identical to each other, a matching key is set between the companies.

For example, the matching unit 12 compares the company information contained in the company data input through the data input unit 11 and the company information contained in the company data already registered in the company data storage unit 21 with each other. If information is identical in any one of the following sets, it is determined that the corresponding companies are identical, a matching key is set between the companies.

(1) name of company+phone number

(2) name of company+facsimile number

(3) name of company+representative's name

(4) name of company+URL (domain)

The matching unit 12 determines whether or not an individual person specified by the company data input through the data input unit 11 is identical to an individual person specified by the company data already registered in the company data storage unit 21 on the basis of the information on the individual person. If it is determined that they are identical, a matching key is set between the individual persons. For example, the matching unit 12 compares the information on the individual person contained in the company data input through the data input unit 11 with the information on the individual person contained in the company data already registered in the company data storage unit 21. When the name and the mail address match, it is determined that the individual persons are identical, and a matching key is set between the individual persons.

The database registering unit 13 stores the company data input through the data input unit 11 in the company data storage unit 21 by associating information on a company with the information on the individual persons belonging to the corresponding company. In this case, when the matching key is set by the matching unit 12, the database registering unit 13 stores the company data in the company data storage unit 21 along with the matching key. The companies having the same matching key are considered as the same company. Similarly, the individual persons having the same matching key are considered as the same individual person.

The connection update unit 14 stores connection information representing a connection of relationship of individual persons in the company and between the companies in the connection information storage unit 22 on the basis of the company data input through the data input unit 11 (having the matching key set by the matching unit 12 as necessary). For example, when the data input unit 11 inputs business card data possessed by the individual person A, the connection update unit 14 determines there is a connection between the individual person A and the individual person specified by the business card data (connection of the individual persons with each other between the companies) and stores the connection information representing this connection in the connection information storage unit 22.

When the data input unit 11 inputs transactor data of the accepting/ordering system, the connection update unit 14 determines that there is a connection (connection of the individual persons between the companies) between the individual person registered as a staff in charge of the selling company (seller) and the individual person registered as a staff in charge of the purchasing company (buyer) having a transaction relationship with this seller in practice, and stores connection information representing this connection in the connection information storage unit 22.

Note that, for a connection between individual persons in a company, for example, the connection update unit 14 determines that there is a connection between individual persons belonging to the same division and the same company, and stores connection information representing this connection in the connection information storage unit 22. Alternatively, the connection update unit 14 determines that there is a connection between individual persons belonging to the same base point of the same company, and stores connection information representing this connection in the connection information storage unit 22. Note that the method of determining the connection described above is merely for exemplary purposes, and the invention is not limited thereto.

In this manner, the individual persons whose connection information is stored on the basis of the company data input through the data input unit 11 are persons originally having the connection. In comparison, the connection update unit 14 sets connection information between the individual persons for which a new connection is established on the basis of a connection request and a permission to this request as described below in details, and stores the connection information in the connection information storage unit 22 as needed.

The company classification unit 15 classifies companies into three types on the basis of the information stored in the company data storage unit 21 and the connection information storage unit 22. A first type includes companies having an individual person connected with a specific user as seen from the specific user who is one of the individual persons stored in the company data storage unit 21. A second type includes companies having an individual person connected with any other person in the company to which the specific user belongs as seen from the specific user. A third type includes companies not including an individual person not connected with the specific user nor with any individual person in the company to which the specific user belongs as seen from the specific user.

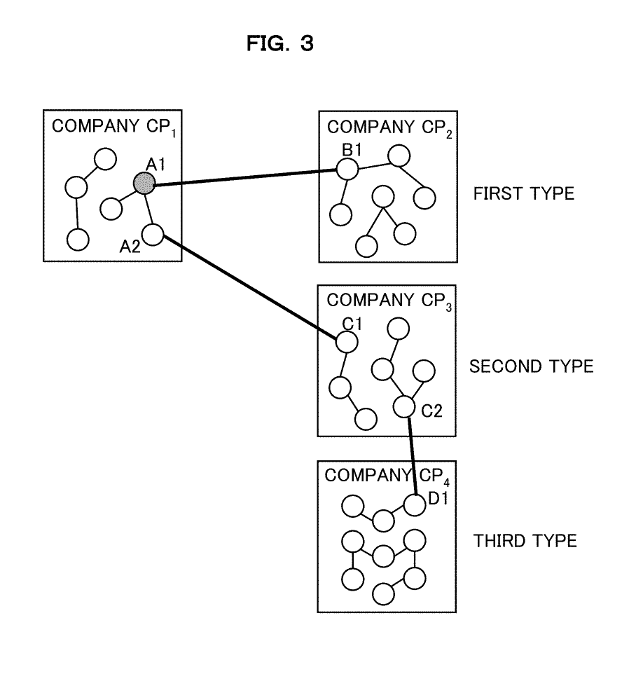

FIG. 3 is a diagram for describing the three types of companies classified by the company classification unit 15 according to this embodiment. FIG. 3 illustrates an example in which, when an individual person A1 belonging to a company CP₁ is extracted as the specific user, the companies CP₂ to CP₄ other than this company CP₁ are classified into three types. Note that, in FIG. 3, each circle mark ◯ indicates an individual person, and a straight line connecting two circle marks ◯ indicates that there is a connection between the individual persons.

For example, as seen from the specific user A1 belonging to the company CP₁, the company CP₂ including the individual person B1 connected with the specific user A1 is classified into the first type of company.

As seen from the specific user A1 belonging to the company CP₁, the company CP₃ including an individual person C1 who has no connection with the specific user A1 but has a connection with another individual person A2 of the company CP₁ to which the specific user A1 belongs is classified as a second type of company. Note that, when the individual person A2 belonging to the company CP₁ is extracted as the specific user, the company CP₃ including the individual person B1 having a connection with the specific user A2 is classified into the first type of company.

As seen from the specific user A1 belonging to the company CP₁, a company CP₄ including no individual person who has a connection with the specific user A1 or with any one of individual persons of the company CP₁ to which the specific user A1 belongs is classified into the third type of company. Note that, when the individual person C2 belonging to the company CP₃ is extracted as the specific user, a company CP₄ including the individual person D1 having a connection with the specific user C2 is classified into the first type of company. In addition, when an individual person C1 belonging to the company CP₃ is extracted as the specific user, a company CP₄ including an individual person D1 having a connection with another individual person C2 of the company CP₃ to which the specific user C1 belongs is classified into the second type of company.

As recognized from the aforementioned description, a plurality of companies CP₁ to CPₙ are not absolutely classified into first to third types, but are classified into any one of first to third types relatively as seen from a specific user. That is, when the specific user extracted from the company data storage unit 21 changes, the classification types of the companies CP₁ to CPₙ also change.

Specifically, for example, when an individual person A1 logs in the server device 100 from the user terminal 200, the company classification unit 15 classifies each companies CP₁ to CPₙ by using the individual person A1 as the specific user. The operation interface control unit 16 and the type-based connection request unit 17 described below provide functionality corresponding to a result of the classification to the user A1.

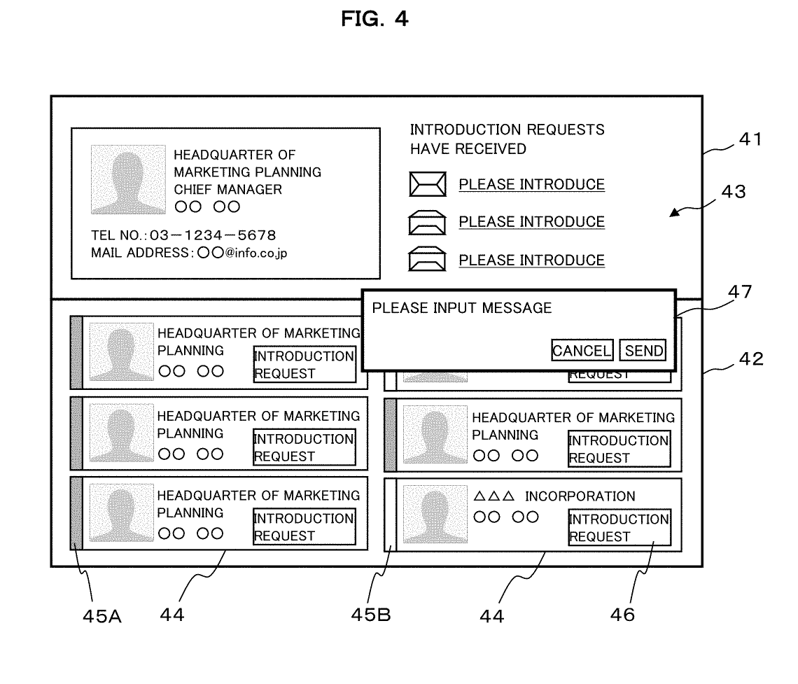

The operation interface control unit 16 provides an operation interface for requesting a connection from the specific user to a new individual person to the user terminal 200 of the specific user by using different methods depending on the type of the company classified by the company classification unit 15. For example, when the specific user desires to request a connection to an individual person belonging to the first type of company, the operation interface control unit 16 provides an operation screen unique to this case (refer to FIG. 4) to the user terminal 200.

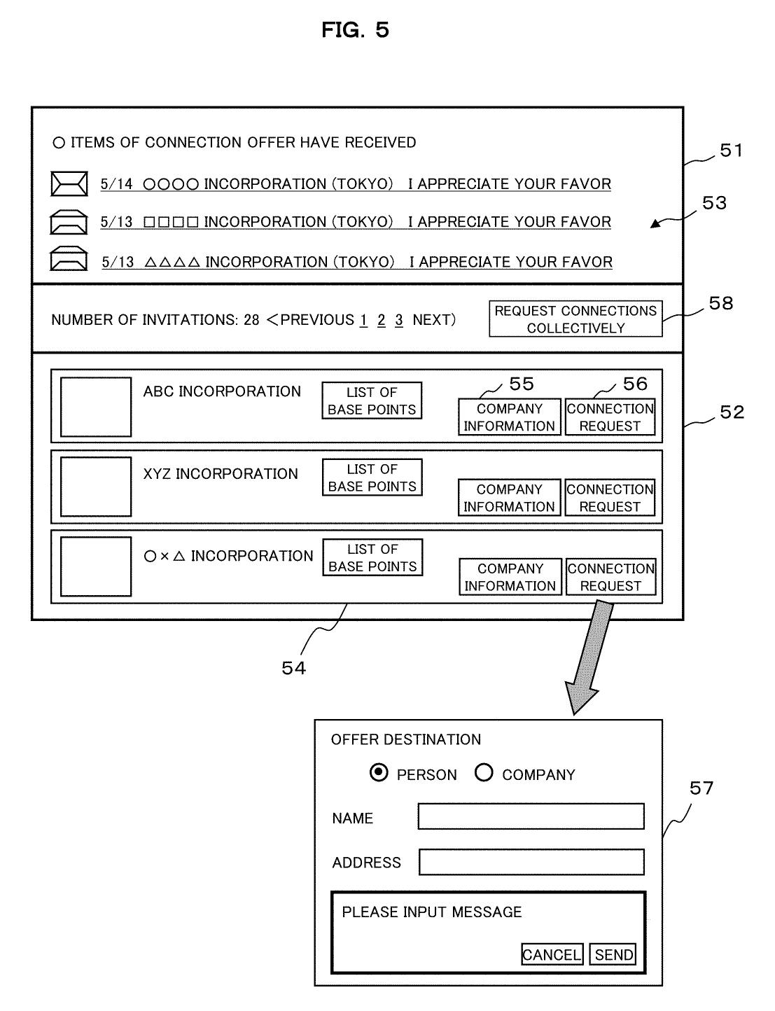

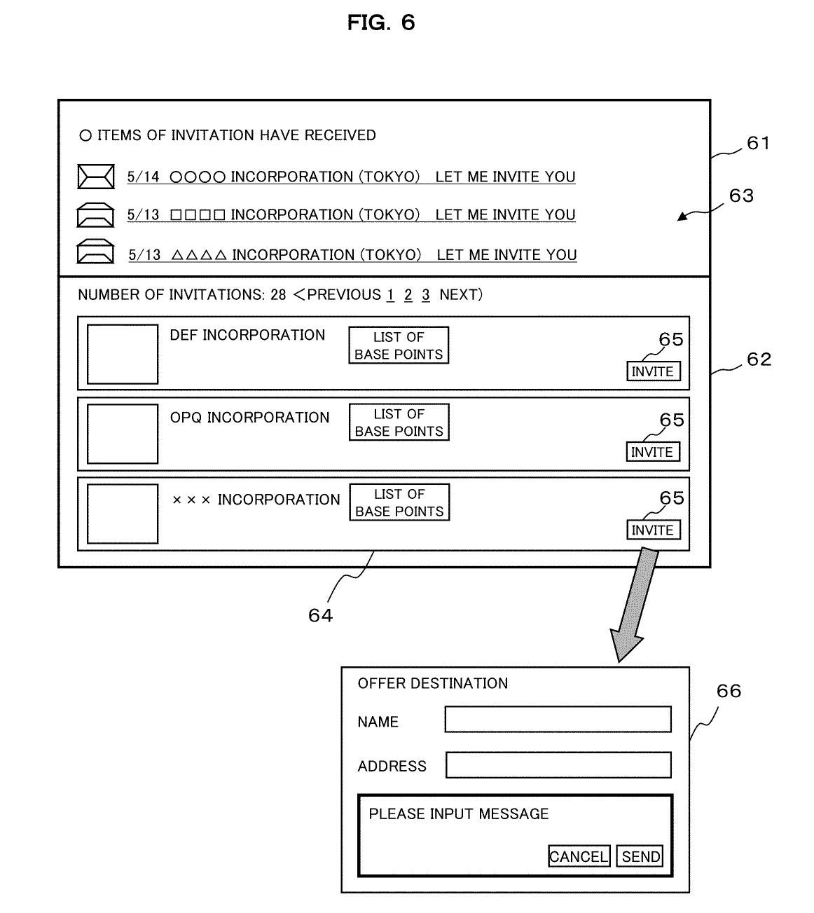

When a specific user desires to request a connection to an individual person belonging to the second type of company, the operation interface control unit 16 provides an operation screen unique to this case (refer to FIG. 5) to the user terminal 200. In addition, when a specific user desires to request a connection to an individual person belonging to the third type of company, the operation interface control unit 16 provides an operation screen unique to this case (refer to FIG. 6) to the user terminal 200. The operation screens of FIGS. 4 and 5 contain operation interfaces for requesting a connection to a new individual person from the specific user. Note that FIGS. 4 to 6 will be described below in more details.

When a connection is requested through a manipulation on the operation interface provided by the operation interface control unit 16, the type-based connection request unit 17 extracts an individual person who satisfies the extraction condition out of individual persons stored in the company data storage unit 21 on the basis of the extraction condition depending on the company type classified by the company classification unit 15. In addition, the type-based connection request unit 17 notifies this extracted individual person of a fact that there is a connection request from the specific user.

This notification is performed, for example, by sending an e-mail to the mail address stored in the company data storage unit 21. Alternatively, the notification may be performed to user ID allocated to each individual person, so that the content of the notification may be displayed on a display screen created for a log-in individual person when each individual person logs in the server device 100 from the user terminal 200.

When a specific user requests a connection to an individual person belonging to the first type of company, the type-based connection request unit 17 extracts an individual person (hereinafter, referred to as a connected individual person) who already has a connection with the specific user in the first type of company, and notifies the extracted connected individual person of the introduction request for another individual person belonging to the first type of company.

Note that, according to this embodiment, the type-based connection request unit 17 extracts the connected individual person selected by the specific user from the company data storage unit 21. For example, in the example of FIG. 3, when the specific user A1 belonging to the company CP₁ desires to have another individual person belonging to the company CP₂ introduced by the individual person B1 (connected individual person) of the company CP₂ already having a connection with the specific user A1, the connection request (notification of the introduction request) may be performed by selecting the connected individual person B1 of the company CP₂.

When the specific user requests a connection to an individual person belonging to the second type of company, the type-based connection request unit 17 extracts an individual person belonging to the second type of company designated by the specific user or a particular group (base point) of that company, and notifies the extracted individual person of a fact that there is a connection request. For example, in the example of FIG. 3, when the specific user A1 belonging to the company CP₁ desires to obtain a connection with anyone who belongs to a company CP₃ which has no connection with the specific user A1 as an individual person, but has a connection as a company (company CP₃ including the individual person C1 having a connection with another individual person A2 of the company CP₁ to which the specific user A1 belongs), the connection request described above may be performed.

When the specific user requests a connection to an individual person belonging to the third type of company, the type-based connection request unit 17 extracts an individual person designated by the specific user out of the individual persons belonging to the third type of company and notifies the extracted individual person of invitation. For example, in the example of FIG. 3, when the specific user A1 belonging to the company CP₁ desires to obtain a connection with a person who belongs to the company CP₄ which has no connection with the specific user A1 as an individual person and has no connection as a company, the aforementioned connection request (notification of invitation) may be performed.

When the individual person who receives the connection request through the type-based connection request unit 17 performs a manipulation for permission on the user terminal 200, the permission receive unit 18 receives this permission. In addition, the permission receive unit 18 notifies the connection update unit 14 of this permission. When the permission receive unit 18 receives the permission from the individual person who receives the connection request through the type-based connection request unit 17, the connection update unit 14 additionally stores connection information representing a relationship of new connection between the specific user and the individual person who performs permission in the connection information storage unit 22.

For example, when the specific user performs a request of a connection (notification of the introduction request) to the connected individual person belonging to the first type of company, and an individual person who receives the notification from the connected individual person notified of this introduction request (an individual person who indirectly receives the connection request via the connected individual person) performs a manipulation for permission, the connection update unit 14 additionally stores connection information representing a relationship of new connection between the specific user and another individual person who performs the permission in the connection information storage unit 22.

When the specific user performs a request a connection to a second type of company designated by the specific user or a particular base point of the second type of company, and someone of that company (or the base point) performs a manipulation for permission, the connection update unit 14 additionally stores connection information representing a relationship of new connection between the specific user and the individual person who performs the permission in the connection information storage unit 22.

When the specific user performs a request of a connection (notification of invitation) to an individual person belonging to a third type of company, and the individual person receiving this invitation performs a manipulation for permission, the connection update unit 14 additionally stores connection information representing a relationship of new connection between the specific user and the individual person who performs the permission in the connection information storage unit 22.

FIG. 4 is a diagram illustrating an exemplary operation screen provided by the operation interface control unit 16 when a specific user who logs in the server device 100 requests a connection to an individual person belonging to the first type of company. The operation screen of FIG. 4 has a self-information field 41 for displaying information regarding the specific user and a counterpart-information field 42 for displaying information regarding the connected individual person connected with this specific user.

On the self-information field 41, a notification message 43 for notifying that an introduction request has received from somebody else is displayed. The specific user may display the message of the introduction request from the counterpart by selecting and pressing a desired notification message 43. In addition, the specific user who receives this introduction request may select one of individual persons who are likely to meet the request of the counterpart from among the individual persons belonging to the same company as that of the specific user, and notify that there is an introduction request.

Various methods may be employed to provide notification of this introduction request. For example, a list display button may be provided on the message display screen displayed by selecting the desired notification message 43, and an individual person list of the company connected with the specific user may be displayed in a pop-up window in response to pressing of this list display button. In addition, any individual person selected by the specific user from the list is notified of the introduction request. Note that the method of providing notification of the introduction request described here is merely for exemplary purposes, and is not intended to limit the invention.

There are one or more tags 44 in the counterpart-information field 42. In addition, information regarding one or more connected individual persons connected with the specific user is displayed on each tag 44. Bars 45A and 45B indicating whether the connection is within the same company or between different companies as seen from the specific user are displayed in the left end of each tag 44. In the example of FIG. 4, the bar 45A indicates that the connection is within the same company, and the bar 45B indicates that the connection is between different companies.

An introduction request button 46 is displayed on each tag 44. When the specific user presses the introduction request button 46 of a desired tag 44, the message input screen 47 is popped up. The specific user inputs an introduction request message to the message input screen 47 and presses the send button so as to request introduction of another individual person to the connected individual person selected by pressing the introduction request button 46.

For example, it is assumed that the operation screen of FIG. 4 is displayed for the specific user A1 belonging to the company CP₁ illustrated in FIG. 3. In this case, when the specific user A1 presses the introduction request button 46 of the tag 44 corresponding to the connected individual person B1 of the company CP₂ already having the connection, the type-based connection request unit 17 extracts the connected individual person B1 from the company data storage unit 21. In addition, when the specific user A1 inputs the introduction request message on the message input screen 47 displayed in the pop-up window as illustrated in FIG. 4 and presses the send button, the type-based connection request unit 17 notifies the extracted connected individual person B1 of the introduction request. When the connected individual person B1 notified of this introduction request performs a manipulation for permission, a new connection can be established between the specific user A1 of the company CP₁ and the individual person B1 of the company CP₂ classified into the first type as seen from the specific user A1.

Alternatively, although not illustrated in FIG. 4, a connection inquiry button may be provided in each tag 44. In this case, when the specific user presses the connection inquiry button of a desired tag 44, information on the individual persons connected to the connected individual person selected by pressing the connection inquiry button within the company may be displayed as a list. As a result, it is possible to check who is connected to the counterpart out of the individual persons before the introduction is requested by pressing the introduction request button 46. Therefore, it is possible to request introduction of an individual person having a feature as close to desire as possible.

Alternatively, the specific user A1 may request introduction by pressing the introduction request button 46 of the tag 44 corresponding to the individual person A2 already having a connection in the same company as that of the specific user A1. In this case, the type-based connection request unit 17 extracts the individual person A2 already having a connection with the specific user A1 from the company data storage unit 21. In addition, when the specific user A1 inputs an introduction request message on the message input screen 47 displayed in the pop-up window and presses the send button, the type-based connection request unit 17 notifies the extracted connected individual person A2 of the introduction request. In this case, the introduction request may be performed to request introduction of the individual person C1 of the company CP₃ having a connection with the individual person A2.

The individual person A2 receiving this introduction request can notify the individual person C1 of the company CP₃ that there is an introduction request from the specific user A1. In addition, when the individual person C1 performs a manipulation for permission, a new connection can be established between the specific user A1 of the company CP₁ and the individual person C1 of the company CP₃ classified into the second type as seen from the specific user A1.

FIG. 5 is a diagram illustrating an exemplary operation screen provided by the operation interface control unit 16 when a specific user who logs in the server device 100 requests a connection to an individual person belonging to the second type of company. The operation screen of FIG. 5 has a self-information field 51 for displaying information regarding the specific user and a counterpart-information field 52 for displaying information regarding a counterpart company connected with the specific user as the second type of company.

A notification message 53 for notifying that a connection request based on the second type has received from somebody else is displayed on the self-information field 51. The connection request message from the counterpart can be displayed as the specific user selects and presses the desired notification message 53. In addition, the specific user who receives this connection request may perform a manipulation for permission.

Various methods may be employed to perform this manipulation for permission. For example, a permission button may be provided on the message display screen displayed by selecting a desired notification message 53, so that permission is performed by pressing this permission button. Note that the permission method described above is merely for exemplary purposes, and is not intended to limit the invention.

Note that it is preferable that information on the counterpart who requested the connection (information on the company and the individual person) can be checked before the individual person receiving the connection request performs the manipulation for permission. Various methods may be employed to check this information. For example, a counterpart information display button may be provided on the message display screen displayed as the specific user selects a desired notification message 53, so that information on the counterpart who performs the connection request may be read from the company data storage unit 21 in response to pressing of this counterpart information display button and may be displayed them in a pop-up window. Note that the method described above is merely for exemplary purposes, and is not intended to limit the invention.

The counterpart-information field 52 has one or more tags 54. In addition, information regarding one or more companies connected with the specific user as the second type of company is displayed in each tag 54. Furthermore, the company information display button 55 and the connection request button 56 are displayed on each tag 54.

A hyperlink to a URL stored in the company data storage unit 21 is set in the company information display button 55. Therefore, as the specific user presses the company information display button 55 of the desired tag 54, information regarding the company corresponding to the selected tag 54 can be displayed and read. Alternatively, when the specific user selects and presses the company information display button 55 of the desired tag 54, the information on the company corresponding to this tag 54 may be read from the company data storage unit 21 and may be displayed in a pop-up window.

As the specific user presses the connection request button 56 of a desired tag 54, the message input screen 57 is displayed in a pop-up window. When the specific user knows information on the individual person whom the specific user desires to make a connection request to within the counterpart company selected by pressing the connection request button 56, the specific user may perform the connection request by setting this individual person as a destination on this message input screen 57. In this case, the connection request to the individual person can be performed by selecting a radio button of the individual person, inputting a name and a mail address of the individual person, and a desired message, and pressing the send button.

Meanwhile, when the specific user does not know information on the individual person whom the specific user desires to make a connection request to within the selected counterpart company, the specific user may perform the connection request by setting the company or the base point as a destination. When the connection request is performed by setting the company as the destination, the connection request to the company can be performed by selecting a radio button of the company, inputting a desired message, and pressing the send button. In addition, when the connection request is performed by setting the base point as the destination, the connection request to the base point can be performed by selecting a radio button of the company, inputting the base point (an input field is displayed by pressing the radio button of the company), inputting a desired message, and pressing the send button.

Note that a collective connection request button 58 is also displayed in the counterpart-information field 52. The specific user can perform the connection request to all of the companies displayed in the counterpart-information field 52 by pressing this collective connection request button 58.

FIG. 6 is a diagram illustrating an exemplary operation screen provided by the operation interface control unit 16 when a specific user who logs in the server device 100 requests a connection to an individual person belonging to the third type of company. The operation screen of FIG. 6 has a self-information field 61 for displaying information regarding the specific user, and a counterpart-information field 62 for displaying information regarding the third type of company that does not have a connection with the specific user.

A notification message 63 for notifying that an invitation notification has received from someone else is displayed on the self-information field 61. The specific user may display an invitation message from the counterpart by selecting and pressing a desired notification message 63. In addition, the specific user who receives this invitation may perform a manipulation for permission.

Various methods may be employed as a method of the manipulation for permission. For example, a permission button may be provided on the message display screen displayed by selecting a desired notification message 63, and the permission may be performed by pressing this permission button. Note that the permission method described above is merely for exemplary purposes, and is not intended to limit the invention.

Note that it is preferable that information on the counterpart who performs invitation (information on the company and the individual person) can be checked before the individual person receiving the invitation performs the manipulation for permission. Various methods may be employed as a method of this checking. For example, a counterpart information display button may be provided on the message display screen displayed as the specific user selects a desired notification message 63, so that information on the counterpart who performs the invitation may be read from the company data storage unit 21 in response to pressing of this counterpart information display button and may be displayed them in a pop-up window. Note that the method described above is merely for exemplary purposes, and is not intended to limit the invention.

There are one or more tags 64 in the counterpart-information field 62. In addition, information regarding one or more companies classified into the third type in a relationship with the specific user is displayed in each tag 64. An invitation button 65 is displayed in each tag 64.

As the specific user presses the invitation button 65 of the desired tag 64, the message input screen 66 is displayed in a pop-up window. Using this message input screen 66, the specific user may perform a connection request (invitation) by setting an individual person whose name and mail address is known within the counterpart company selected by pressing the invitation button 65 as a destination. That is, a connection request (invitation) to the designated individual person can be performed by inputting a name and a mail address of the individual person to be invited and a desired message and pressing the send button.

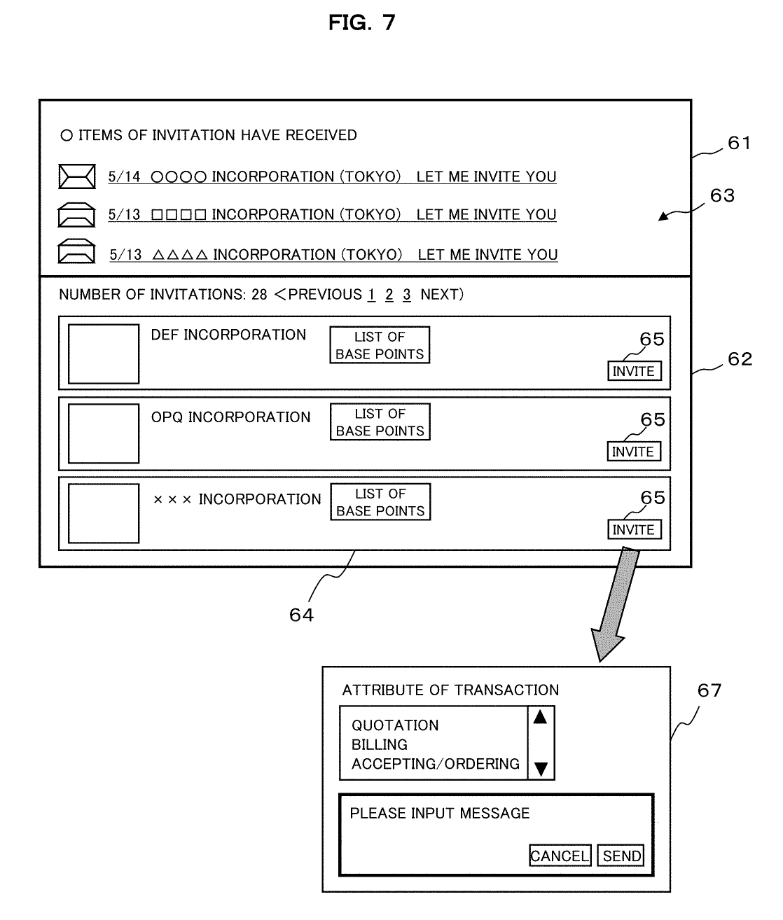

Note that the example of FIG. 6 is an effective method when there is an individual person in the selected counterpart company whose name and mail address is known by the specific user who manipulates the operation screen. In comparison, the connection request (invitation) may be performed by selecting a desired company even when there is no individual person whose name and mail address is known at all. FIG. 7 is a diagram illustrating an exemplary operation screen provided by the operation interface control unit 16 when such a connection request is performed. Note that, in FIG. 7, like reference numerals denote like elements as in FIG. 6, and they will not be described repeatedly here.

As a specific user presses the invitation button 65 of the tag 64 regarding a desired company, the message input screen 67 is displayed in a pop-up window. Using this message input screen 67, the specific user designates an attribute used in the connection request (invitation). The attribute indicates what type of the transaction a staff to be connected takes in charge. For example, the attribute may include quotation, billing, accepting and ordering, or the like. When the quotation is designated as the attribute, this means that a connection to an individual person in charge of the quotation is requested.

The specific user can perform the connection request (invitation) to the selected company by pressing the invitation button 65 of the tag 64 regarding the desired company, designating a desired attribute and inputting a desired message in the message input screen 67, and then pressing the send button.

When the connection request to the third type of company is performed in this manner, the type-based connection request unit 17 extracts an individual person satisfying a predetermined extraction condition relating to the designated attribute out of the individual persons stored in the company information storage unit 21, and notifies the extracted individual persons of a fact that there is a connection request from the specific user.

The extraction condition in this case includes a pair of the following priority criteria regarding the designated attribute.

First priority criterion: individual person having a top permission authority

Second priority criterion: individual person having the largest number of connections.

Note that, in order to extract the individual person on the basis of this priority criteria, information regarding presence of the top permission authority and information regarding the number of connections are stored in the company information storage unit 21 by associating with each individual person. The information regarding presence of the top permission authority may be additionally registered, for example, in the individual person information stored in the company information storage unit 21 in response to a user's manipulation from the user terminal 200.

For example, when a connection request is performed by designating “quotation” as the attribute, the type-based connection request unit 17 extracts an individual person having the top permission authority for the quotation as the first priority criterion and notifies the extracted individual person of a fact that there is a connection request from the specific user. Note that, when there area plurality of individual persons who satisfy the first priority criterion, or there is no individual person who satisfies the first priority criterion, an individual person who has the largest number of connections is extracted as the second priority criterion, and the extracted individual person is notified of a fact that there is a connection request from the specific user.

Similarly, when the connection request is performed by designating “accepting and ordering” as the attribute, the type-based connection request unit 17 extracts an individual person having the top permission authority regarding “accepting and ordering” as the first priority criterion, and notifies the extracted individual person of a fact that there is a connection request from the specific user. Note that, when there are a plurality of individual persons who satisfy the first priority criterion, or there is no individual person who satisfies the first priority criterion, an individual person who has the largest number of connections is extracted as the second priority criterion, and the extracted individual person is notified of a fact that there is a connection request from the specific user.

When the individual person receiving the notification as described above performs permission, a new connection is established. That is, when the individual person receiving the connection request as described above performs a manipulation for permission, the connection update unit 14 additionally stores connection information representing a relationship of new connection between the specific user who performs the connection request and the individual person who performs the permission in the connection information storage unit 22.

Meanwhile, when the individual person who receives the notification of the connection request does not perform the permission, the notification may be transmitted to another individual person in the same company. When another individual person who receives this transmitted notification performs permission, a new connection is established with another individual person who performs this permission. That is, when another individual person notified of the transmitted connection request performs a manipulation for permission, the connection update unit 14 additionally stores connection information representing a relationship of new connection between the specific user who performs the connection request and another individual person who performs the permission in the connection information storage unit 22.

Here, assuming that another individual person received the transmitted notification regarding the connection request sent to a certain company by designating the attribute performs the manipulation for permission, the type-based connection request unit 17 may change a condition for extracting the individual person from the company when the connection request is performed to that company by designating the same attribute as that of the permission after the permission. That is, instead of the first and second priority criteria described above, a new criterion (learning rule) is employed such that another individual person who receives the transmitted notification of the connection request and performs the permission is extracted with a higher priority.

In this case, after a learning rule is employed for a connection request designating “quotation” as the attribute to the third type of company, for example, when the connection request to that company is performed by designating “quotation” as the attribute, the individual person extracted on the basis of the learning rule instead of the first and second priority criteria is directly notified of a fact that there is a connection request from the specific user. As a result, it is possible to effectively perform the process from the connection request to the permission.

Note that, although an example in which the same extraction condition is used for any attribute here (“the first priority criterion=the individual person having the top permission authority” and “second priority criterion=the individual person having the largest number of connections”) has been described, the extraction condition may be changed for each attribute. In addition, the extraction condition described above is merely for exemplary purposes, and is not intended to limit the invention.

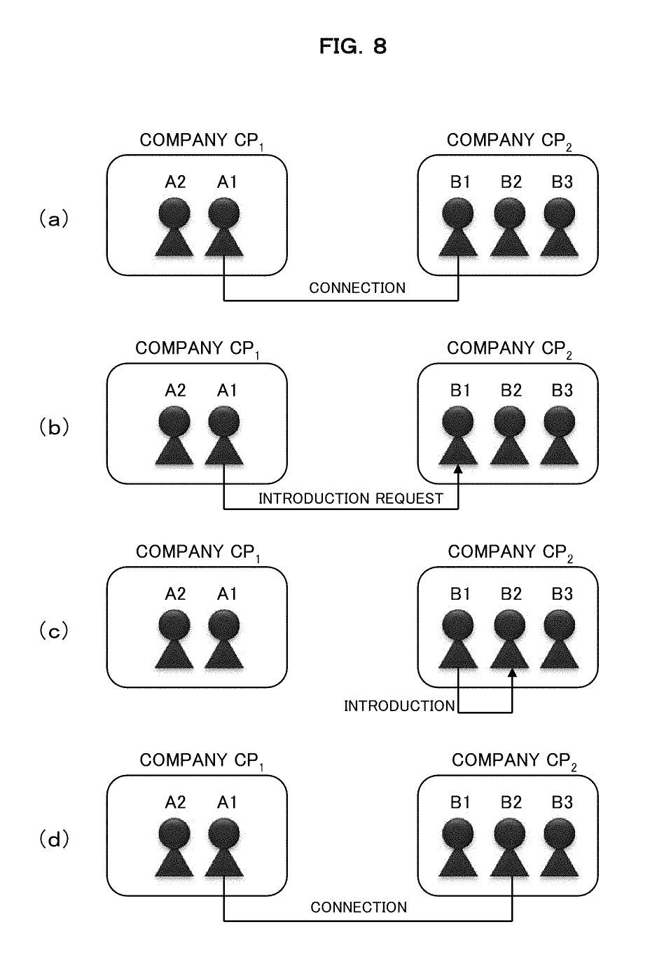

FIG. 8 is a diagram illustrating an exemplary sequence when a specific user A1 of the company CP₁ of FIG. 3 performs an introduction request to an individual person B1 belonging to the first type of company CP₂, and has another individual person belonging to the company CP₂ introduced. As illustrated in FIG. 8(a), the specific user A1 belonging to the company CP₁ and the individual person B1 belonging to the company CP₂ are already connected.

In this case, as illustrated in FIG. 8(b), the specific user A1 belonging to the company CP₁ performs an introduction request to the individual person B1 belonging to the company CP₂. As the individual person B1 receives the introduction request from the specific user A1, individual person B1 selects an individual person B2 who is likely to meet a requirement on the introduction request sent from the specific user A1 out of individual persons belonging to the same company CP₂ as that of the individual person B1, and notification of a fact that there is an introduction request from the specific user A1 is provided as illustrated in FIG. 8(c).

That is, a mail for providing notification of the introduction request is transmitted to the individual person B2 belonging to the company CP₂. In addition, a fact that there is an introduction request from the specific user A1 is displayed on the operation screen provided when the individual person B2 logs in the server device 100. In addition, when the individual person B2 notified of this introduction request performs permission, a new connection is established between the specific user A1 of the company CP₁ and the individual person B2 of the company CP₂ as illustrated in FIG. 8(d).

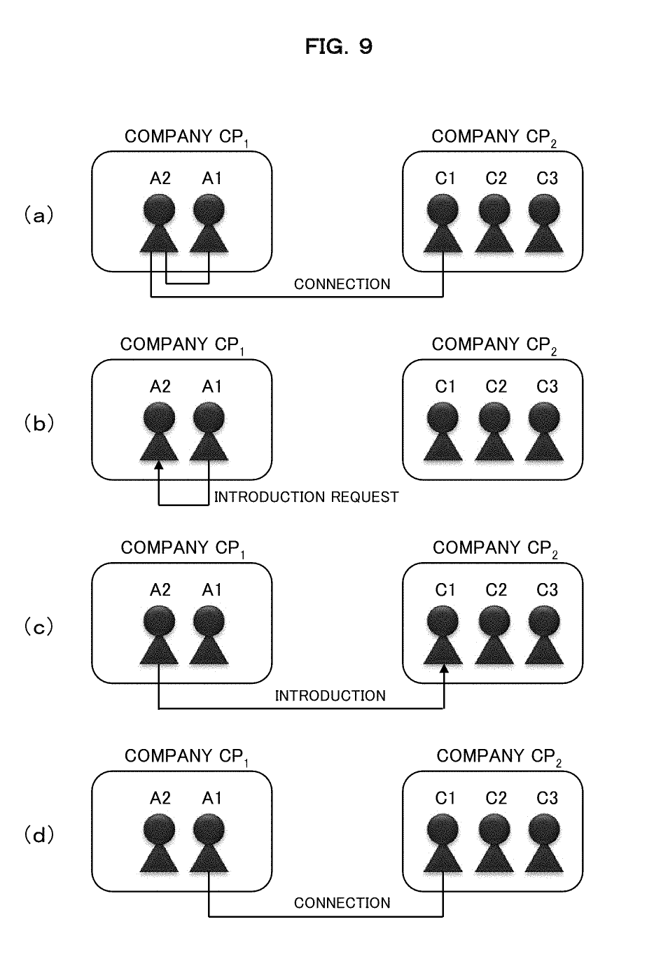

FIG. 9 is a diagram illustrating an exemplary sequence when the specific user A1 of the company CP₁ of FIG. 3 requests introduction to the individual person A2 belonging to the same company CP₁ as that of the specific user A1 and has the individual person C1 of the company CP₃ connected with the individual person A2 introduced. As illustrated in FIG. 9(a), the individual person A2 and the specific user A1 belonging to the company CP₁ are already connected, and the individual person A2 and the individual person C1 belonging to the company CP₃ are already connected.

In this case, as illustrated in FIG. 9(b), the specific user A1 belonging to the company CP₁ performs the introduction request to the individual person A2. As the individual person A2 receives the introduction request from the specific user A1, the individual person C1 of the company CP₃ connected to the individual person A2 is notified of a fact that there is an introduction request from the specific user A1 as illustrated in FIG. 9(c).

That is, a mail for providing notification of the introduction request is transmitted to the individual person C1 of the company CP₃. In addition, a fact that there is an introduction request from the specific user A1 is displayed on the operation screen provided when the individual person C1 logs in the server device 100. In addition, when the individual person C1 receiving the notification of this introduction request performs permission, a new connection is established between the specific user A1 of the company CP₁ and the individual person C1 of the company CP₃ as illustrated in FIG. 9(d).

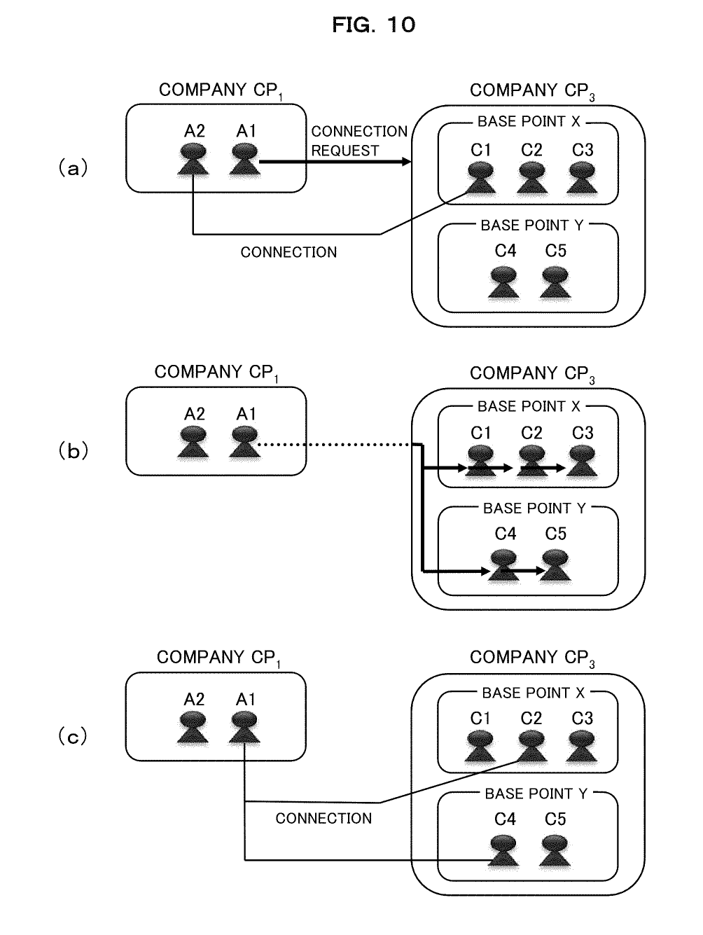

FIG. 10 is a diagram illustrating an exemplary sequence when the specific user A1 of the company CP₁ of FIG. 3 requests a connection to the company CP₃ classified into the second type. As illustrated in FIG. 10(a), the individual person A2 of the company CP₁ is already connected with the individual person C1 of the company CP₃, but the specific user A1 is not connected with anyone of the company CP₃.

In this case, as illustrated in FIG. 10(a), the specific user A1 belonging to the company CP₁ requests a connection, for example, to whole of the company CP₃. Then, as illustrated in FIG. 10(b), a connection request mail is transmitted to all of the individual persons C1 to C5 belonging to the company CP₃. In addition, a fact that there is a connection request from the specific user A1 is displayed on the operation screen provided when the individual persons C1 to C5 log in the server device 100.

When someone of the individual persons C1 to C5 receiving this connection request performs permission, a new connection is established between the specific user A1 of the company CP₁ and the individual person of the company CP₃ who performs permission as illustrated in FIG. 10(c). In the example of FIG. 10(c), two individual persons C2 and C4 perform permission by way of example.

As described above in details, according to this embodiment, as seen from a specific user, companies are classified into a first type of company with which the specific user is connected as an individual person, a second type of company connected as a company, and a third type of company having no connection as an individual person or as a company. In addition, a connection is requested from the specific user to a new individual person using different methods depending on the classified company type. Furthermore, when the individual person receiving the connection request performs a manipulation for permission, a new connection is established between the specific user and the individual person who performs the permission.

In the connection establishment support system configured in this manner according to this embodiment, a user of this system can perform a new connection request using different methods corresponding to three types depending on how the user and a counterpart company or an individual person of the counterpart company are connected. In addition, as the individual person who receives this request performs permission, a new connection (clique) useful in the subsequent transaction can be established. As a result, it is possible to support effective establishment of a clique necessary to expand company transactions.

Note that the aforementioned embodiments are merely an example for embodying the present invention, and should not be construed as a limitation of the technical scope of the invention. That is, various modes of the present invention may be possible without departing from the spirit and scope of the invention.

### REFERENCE SIGNS LIST

11 data input unit
12 matching unit
13 database registering unit
14 connection update unit
15 company classification unit
16 operation interface control unit
17 type-based connection request unit
18 permission receive unit
21 company data storage unit
22 connection information storage unit
100 server device
200 user terminal

1. A connection establishment support system comprising:
a company data storage unit that stores company data including information on a company and information on individual persons belonging to the company by associating the information with each other;
a connection information storage unit that stores connection information representing connection of relationships between individual persons in a company and between companies;
a company classification unit that, as seen from a certain specific user who is one of the individual persons stored in the company data storage unit, classifies the companies into a first type of company including an individual person having a connection with the specific user, a second type of company including an individual person having a connection with someone else of the company to which the specific user belongs, and a third type of company not including an individual person having a connection with the specific user or an individual person of the company to which the specific user belongs, on the basis of the information stored in the company data storage unit and the connection information storage unit;
an operation interface control unit that provides an operation interface for performing a connection request to a new individual person from the specific user using a different method depending on the type of the company classified by the company classification unit;
a type-based connection request unit that, when the connection request is performed by manipulating the operation interface, extracts an individual person satisfying an extraction condition depending on the type of the company from the individual persons stored in the company data storage unit on the basis of the extraction condition, and notifies the extracted individual person of a fact that there is the connection request from the specific user; and
a connection update unit that, when a manipulation for permission is performed by the individual person receiving the connection request through the type-based connection request unit, additionally stores connection information representing a relationship of new connection between the specific user and the individual person who performs the permission in the connection information storage unit.

2. The connection establishment support system according to claim 1, wherein, assuming that the specific user performs the connection request to an individual person belonging to the first type of company, the type-based connection request unit extracts a connected individual person who is an individual person already having a connection with the specific user in the first type of company, and notifies the extracted connected individual person of an introduction request of another individual person belonging to the first type of company, and
when a manipulation for permission is performed by another individual person receiving a notification from the connected individual person notified of the introduction request, the connection update unit additionally stores connection information representing a relationship of new connection between the specific user and the other individual person who performs the permission in the connection information storage unit.

3. The connection establishment support system according to claim 1, wherein, assuming that the specific user performs the connection request to an individual person belonging to the second type of company, the type-based connection request unit extracts an individual person belonging to the second type of company or a particular group of the second type of company designated by the specific user and notifies the extracted individual person of a fact that there is a connection request, and
when a manipulation for permission is performed by anyone of individual persons of the company or the group receiving the connection request, the connection update unit additionally stores connection information representing a relationship of new connection between the specific user and the individual person who performs the permission in the connection information storage unit.

4. The connection establishment support system according to claim 1, wherein, assuming that the specific user performs the connection request to an individual person belonging to the third type of company, the type-based connection request unit extracts an individual person designated by the specific user from the individual persons belonging to the third type of company and notifies the extracted individual person of invitation, and
when a manipulation for permission is performed by the individual person who receives the invitation, the connection update unit additionally stores connection information representing a relationship of new connection between the specific user and the individual person who performs the permission in the connection information storage unit.

5. The connection establishment support system according to claim 1, wherein, assuming that the specific user performs the connection request to an individual person belonging to the third type of company, the operation interface control unit provides an operation interface for performing a connection request to the third type of company by designating an attribute of a desired transaction,
the type-based connection request unit extracts one of individual persons belonging to the third type of company depending on a predetermined extraction condition relating to the attribute designated using the operation interface and notifies the extracted individual person of a fact that there is a connection request from the specific user, and
when a manipulation for permission is performed by the notified individual person, the connection update unit additionally stores connection information representing a relationship of new connection between the specific user and the individual person who performs the permission in the connection information storage unit.

6. The connection establishment support system according to claim 5, wherein, assuming that a manipulation for permission is performed by another individual person receiving transmitted notification from the notified individual person, the connection update unit additionally stores connection information representing a relationship of new connection between the specific user and the other individual person who performs the permission in the connection information storage unit, and
assuming that the manipulation for permission is performed by the other individual person receiving the transmitted notification, when a connection is subsequently requested to the same company as that of the other individual person by designating the same attribute as that set at the time of the permission, the type-based connection request unit extracts the other individual person from the third type of company on the basis of a learning rule in which the other individual person is extracted with a higher priority instead of a predetermined extraction condition relating to the attribute.
